(19) United States
(12) Patent Application Publication
(10) Pub. No.: US 2008/0126650 A1
(43) Pub. Date: May 29, 2008

(54) Methods and apparatus for parallel processing in system management mode

(76) Inventors: Robert C. Swanson, Olympia, WA (US); Michael A. Rothman, Sammamish, WA (US); Vincent J. Zimmer, Federal Way, WA (US); Fernando A. Lopez, Hillsboro, OR (US); Mallik Bulusu, Olympia, WA (US)

Correspondence Address: INTEL CORPORATION;c/o INTELLEVATE, LLC, P.O. BOX 52050, MINNEAPOLIS, MN, 55402, US

(21) Appl. No.: 11/525,617

(22) Filed: Sep. 21, 2006

(51) Int. Cl. G06F 13/24; G06F 11/14

(52) U.S. Cl. 710/267; 714/16; 714/E11.112

(57) ABSTRACT

A processing system includes multiple processing units. After multiple event handlers have been dispatched to execute concurrently in different processing units of the processing system in a hidden execution mode, the processing system automatically determines whether the multiple event handlers successfully complete. If an event handler among the multiple dispatched event handlers fails, the processing system automatically dispatches another event handler to perform operations associated with the event handler that failed. In an embodiment, the hidden execution mode is a system management mode (SMM), and the multiple event handlers are dispatched in response to a system management interrupt (SMI) or a platform management interrupt (PMI). In an embodiment, the processing system may determine why the dispatched event handler failed, and may performing a corrective operation before dispatching another event handler to perform the operations associated with the event handler that failed. Other embodiments are described and claimed.

### FIELD OF THE INVENTION

The present disclosure relates generally to the field of data processing, and more particularly to methods and related apparatus to support parallel processing in system management mode.

### BACKGROUND

A processing system may include random access memory (RAM) and multiple processing units. The processing units may share some or all of the RAM. An operating system (OS) and applications to execute on top of the OS may use parallel programming techniques to take advantage of multiple processing units in a processing system.

Some computing platforms support system management mode (SMM), which is a special-purpose operating mode or execution mode for handling low-level or system-wide functions. For example, a processing system may use SMM to execute code that provides for or handles chipset errata; errors that impact reliability, availability, and scalability (RAS); power management features; system hardware control; and/or advanced systems management features. The code to be executed in SMM (i.e., the SMM code) may be loaded by the platform's firmware or basic input/output system (BIOS), for instance. SMM is considered a hidden execution mode because the OS and the software applications executing on top of the OS cannot utilize SMM, and the OS and the user-level applications generally operate as if SMM does not exist. In addition, the memory used by the SMM code, referred to as the system management RAM (SMRAM), is inaccessible to the OS and the user-level software applications. However, SMRAM is accessible to the processing units when they are executing in SMM.

A processing system may use SMM to service events such as system management interrupts (SMIs) or platform management interrupts (PMIs), for example. The terms “xMI” and “hidden execution mode event” may be used to denote SMIs, PMIs, and any similar types of interrupts or events.

Conventionally, SMM code may include a single entry point that the boot strap processor (BSP) jumps to when the processor xMI signal is asserted. The BSP may then switch context from the current mode (e.g., real mode or protected mode) to SMM, and application processors (APs) may be put to sleep. The boot strap processor (BSP) may then traverse a linked list of xMI handlers. An xMI handler in the chain may claim the xMI and perform the function associate with that handler. The xMI handler may then wake the APs and then switch context back to the mode that was being used before the xMI was asserted. For purposes of this disclosure, protected mode, real mode, and any similar execution modes outside of SMM may be referred to as legacy execution mode.

A system may include multiple entities that can generate xMIs at the same time or substantially the same time. Conventionally, the first xMI would be handled and the system would return from SMM to legacy execution mode. The xMI signal (e.g., SMI#) would then be immediately re-asserted. This will cause the overhead of putting the APs to sleep and waking them up multiple times, and performing multiple context switches.

Additionally, RAS features and advanced server features may use xMI handlers to perform various operations. For instance, SMM may be used for legacy console redirection. This advanced systems management feature may write entire video graphics array (VGA) pages to a remote console while inside of an xMI handler, which is a time consuming process.

SMM may be used in a single-threaded fashion. For example, a conventional system may use a serial process to discover the proper SMI handler. However, U.S. Pat. No. 6,775,728, (hereinafter the “'728 patent”), entitled “Method and System for Concurrent Handler Execution in an SMI and PMI-based Dispatch-Execution Framework,” pertains to methods and apparatus to enable concurrent or parallel execution of event handlers in SMM. The '728 patent is assigned to the same assignee as the current application.

The present disclosure describes enhancements associated with concurrent or parallel execution of SMM event handlers.

### BRIEF DESCRIPTION OF THE DRAWINGS

Features and advantages of the present invention will become apparent from the appended claims, the following detailed description of one or more example embodiments, and the corresponding figures, in which:

FIG. 1 is a block diagram depicting a suitable data processing environment in which certain aspects of an example embodiment of the present invention may be implemented; and

FIGS. 2 and 3 depict a flowchart of a process for concurrently executing multiple event handlers according to an example embodiment of the present invention.

### DETAILED DESCRIPTION

The present disclosure describes means for utilizing multiple processor cores to reduce the number of SMM context switches. The present disclosure also describes means for utilizing multiple processor cores to reduce the execution time spent inside of xMI handlers. It also describes means for addressing a redundancy problem. For example, a server system may include a baseboard management controller (BMC) (e.g., an Intel® Active Management Technology (AMT) controller) that polls the SMI signal on the south bridge or I/O controller hub (ICH) specifically to determine if the BIOS is stuck while executing the SMI handler chain. If the system is stuck in SMM for a long period of time, the BMC may log an error to the event log. The BMC may also be configured to reset the system, which will reduce the reliability and availability of the system. The present disclosure describes means for avoiding such a system reset. It also describes means for effective parallel processing of major xMI-based RAS features.

In an example embodiment, upon xMI assertion, instead of putting the AP's to sleep, the BSP may rendezvous the N application processor cores and slice the xMI handlers into M searchable blocks. Every Nth processor core may search its assigned block and, if the relevant event handler is found in that block, handle the associated xMI source. Once all of the xMI sources are handled, the application cores may return the findings to the BSP. If any of the application cores are not being used, they may be used for higher priority/computing intensive blocks, such as blocks to provide RAS features such as non-native USB handling, legacy console redirection, and advanced error reporting and logging.

Non-native USB processing is required for operating systems like DOS and Windows® (during the OS install), to provide USB device support. Every single node in the USB subsystem can generate a request that needs to be handled. For example if there are multiple USB hubs on the system, and on each hub there are different devices that need servicing, a processing system according to the present disclosure may utilize the additional processing cores to parallelize the USB handling, to minimize the time in the SMM.

Console redirection may also utilize the additional cores to slice the size of the frame buffer array into smaller chunks, by which available cores can concurrently copy the buffer for pushing to a universal asynchronous receiver/transmitter (UART) controller and attached network agents operating on behalf of the overall management infrastructure.

Errors may be classified by their subsystem, and may be searched in parallel by available cores. In addition, time savings may occur while collecting and sending information about the system error to the BMC and/or the larger system management infrastructure. For example, two cores could handle errors associated with the memory controller. The memory controller may include two specific registers, called First Error (FERR) and Next Error (NERR), for instance. Once the SMM code knows the types of errors, it can start the logging process independently of clearing the register states which triggered the assertion of FERR/NERR, which may yield faster execution in the time-critical SMM operation.

Once the application cores are finished with their work, the xMI will be considered handled or finished, and the system may return to the legacy execution mode that was being used before the system entered SMM mode (e.g., protected mode or real mode). Furthermore, if an application core does not return, another application core can recheck the xMI handlers associated with the failed application core, thus providing xMI AP handler redundancy. Thus, the system may be self healing while handling xMIs in SMM.

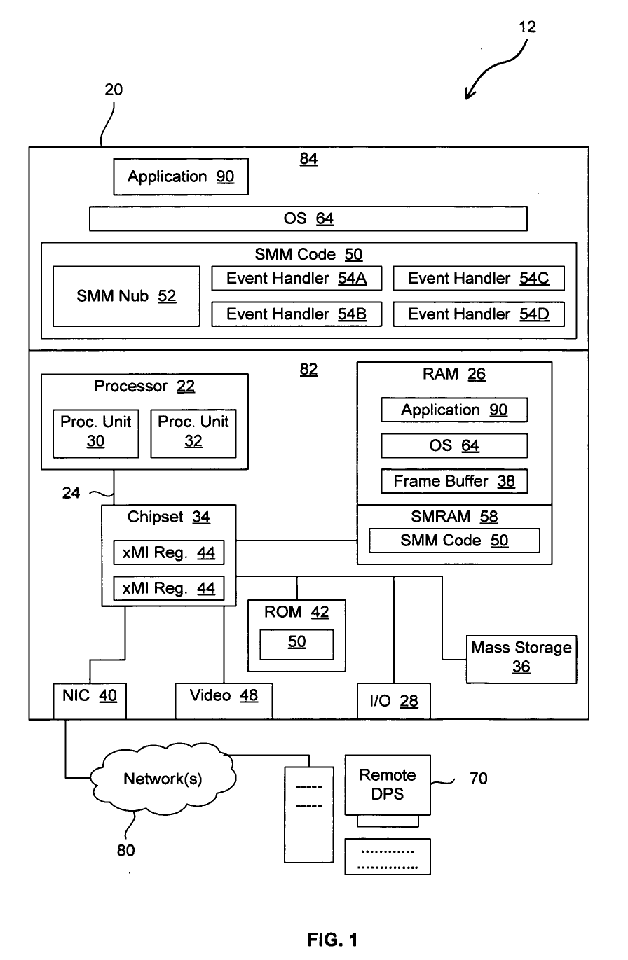

FIG. 1 is a block diagram depicting a suitable data processing environment 12 in which certain aspects of an example embodiment of the present invention may be implemented. Data processing environment 12 includes a processing system 20 that has various hardware components 82, such as a CPU 22 communicatively coupled to various other components via one or more system buses 24 or other communication pathways or mediums. This disclosure uses the term “bus” to refer to shared communication pathways, as well as point-to-point pathways. CPU 22 may include two or more processing units, such as processing unit 30 and processing unit 32. Alternatively, a processing system may include multiple processors, each having at least one processing unit. The processing units may be implemented as processing cores, as Hyper-Threading (HT) technology, or as any other suitable technology for executing multiple threads simultaneously or substantially simultaneously. During the boot process, one of the processing units may be configured to serve as a bootstrap processor (BSP).

As used herein, the terms “processing system” and “data processing system” are intended to broadly encompass a single machine, or a system of communicatively coupled machines or devices operating together. Example processing systems include, without limitation, distributed computing systems, supercomputers, high-performance computing systems, computing clusters, mainframe computers, mini-computers, client-server systems, personal computers, workstations, servers, portable computers, laptop computers, tablets, telephones, personal digital assistants (PDAs), handheld devices, entertainment devices such as audio and/or video devices, and other devices for processing or transmitting information.

Processing system 20 may be controlled, at least in part, by input from conventional input devices, such as keyboards, mice, etc., and/or by directives received from another machine, biometric feedback, or other input sources or signals. Processing system 20 may utilize one or more connections to one or more remote data processing systems 70, such as through a network interface controller (NIC) 40, a modem, or other communication ports or couplings. Processing systems may be interconnected by way of a physical and/or logical network 80, such as a local area network (LAN), a wide area network (WAN), an intranet, the Internet, etc. Communications involving network 80 may utilize various wired and/or wireless short range or long range carriers and protocols, including radio frequency (RF), satellite, microwave, Institute of Electrical and Electronics Engineers (IEEE) 802.11, 802.16, 802.20, Bluetooth, optical, infrared, cable, laser, etc. Protocols for 802.11 may also be referred to as wireless fidelity (WiFi) protocols. Protocols for 802.16 may also be referred to as WiMAX or wireless metropolitan area network protocols, and information concerning those protocols is currently available at grouper.ieee.org/groups/802/16/published.html.

Within processing system 20, processor 22 may be communicatively coupled to one or more volatile or non-volatile data storage devices, such as RAM 26, read-only memory (ROM) 42, mass storage devices 36 such as hard drives, and/or other devices or media, such as floppy disks, optical storage, tapes, flash memory, memory sticks, digital video disks, etc. For purposes of this disclosure, the term “ROM” may be used in general to refer to non-volatile memory devices such as erasable programmable ROM (EPROM), electrically erasable programmable ROM (EEPROM), flash ROM, flash memory, etc. Processor 22 may also be communicatively coupled to additional components, such as video controller 48, integrated drive electronics (IDE) controllers, small computer system interface (SCSI) controllers, universal serial bus (USB) controllers, input/output (I/O) ports 28, input devices such as a keyboard and mouse, etc.

Processor 22, RAM 26, and other components may be connected to a chipset 34. Chipset 34 may include one or more bridges or hubs for communicatively coupling system components. Chipset 34 may include various additional logic and storage components, such as xMI registers 44.

In the example embodiment, when processing system 20 boots, it establishes a hidden, protected area of memory known as SMM memory or SMRAM 58. When the processing units are in SMM, they can use SMRAM 58, but the processing units cannot access SMRAM 58 when they are not operating in SMM. Consequently, OS 64 and applications 90 cannot read or modify the data in SMRAM, and may in fact be completely unaware of its existence.

Some components, such as video controller 48 for example, may be implemented as adapter cards with interfaces (e.g., a PCI connector) for communicating with a bus. In one embodiment, one or more devices may be implemented as embedded controllers, using components such as programmable or non-programmable logic devices or arrays, application-specific integrated circuits (ASICs), embedded computers, smart cards, and the like.

The invention may be described by reference to or in conjunction with associated data including instructions, functions, procedures, data structures, application programs, etc., which, when accessed by a machine, result in the machine performing tasks or defining abstract data types or low-level hardware contexts. Different sets of such data may be considered components of a software environment 84.

For instance, software environment 84 may include an operating system (OS) 64 and on or more applications 90, which processing system 20 may load into RAM 26 for execution. Processing system 20 may obtain OS 64 and application 90 from any suitable local or remote device or devices. In addition, software environment 84 may include SMM code 50.

In one embodiment, processing system 20 loads SMM code 50 into SMRAM 58 from ROM 42 during the boot process, before loading OS 64. In the embodiment of FIG. 1, SMM code 50 includes an SMM nub 52 and various SMM event handlers 54A-54D.

The memory space of processing system 20 may also include various memory ranges to be used by components such as NIC 40 and video controller 48. For instance, the memory space may include a frame buffer 38 to store video data for video controller 48. Frame buffer 38 is illustrated in RAM 26 in FIG. 1. In other embodiments, the actual storage hardware for a frame buffer may reside in a different component, such as on a video controller adapter card, although that storage may be accessed through the physical memory space of a processing system (e.g., starting at the hexadecimal memory address B8000).

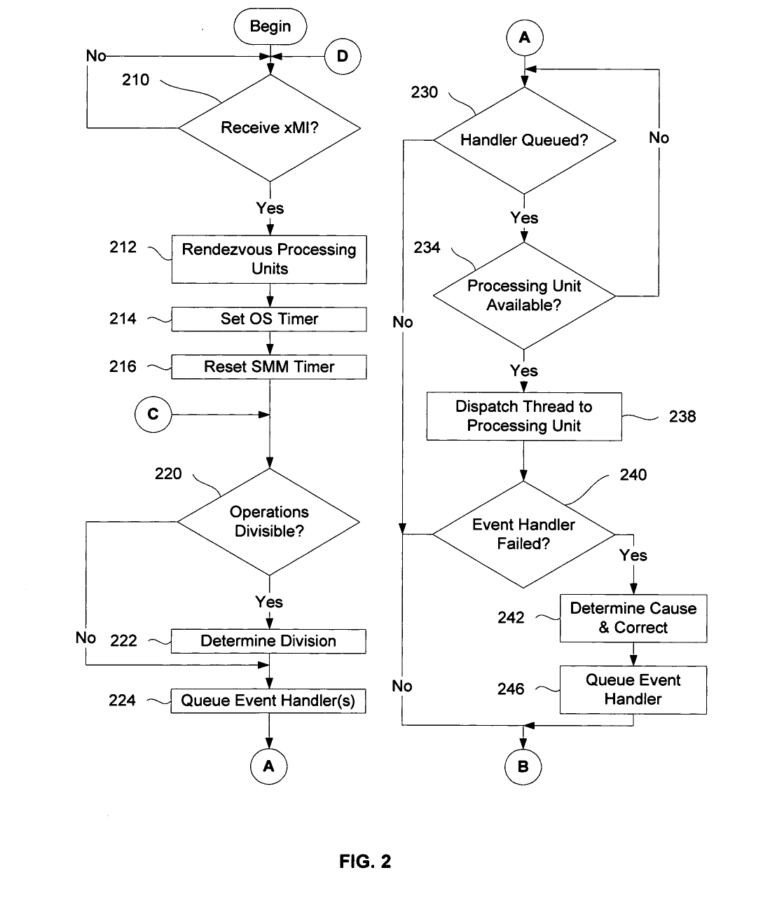

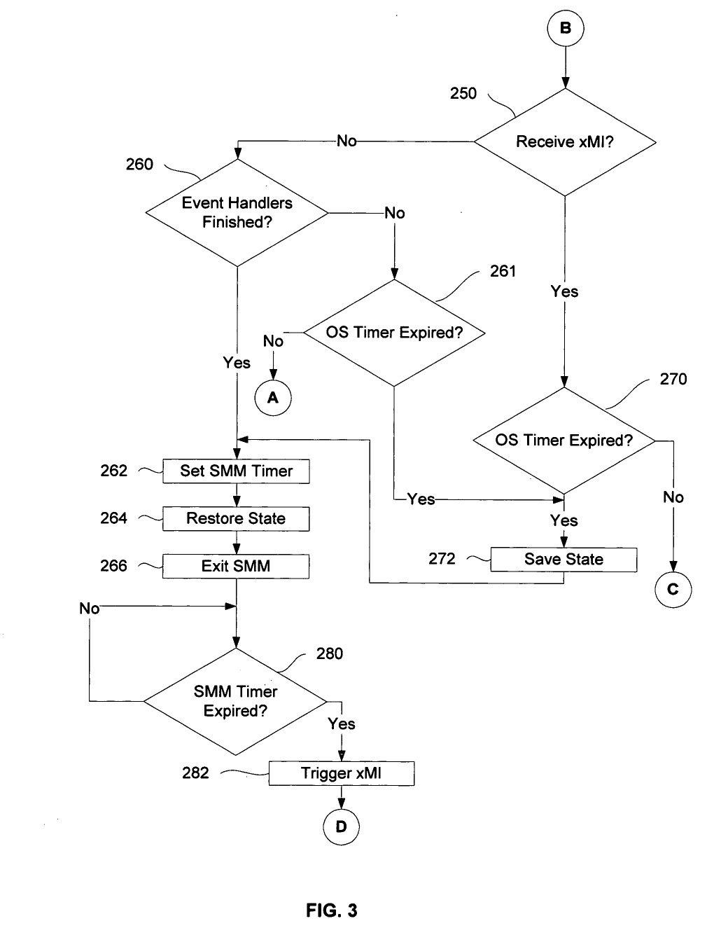

FIGS. 2 and 3 depict flowcharts of an example embodiment of a process for concurrently executing multiple event handlers in the processing system of FIG. 1. The illustrated process may begin after processing system 20 has loaded SMM code 50 and booted to OS 64, for example. Block 210 illustrated that processing system may generally run under control of higher level software, such as OS 64, until an xMI is triggered. Some of the circumstances that may cause an xMI to be triggered include, without limitation, the following:

(a) a memory error;

(b) a signal from a peripheral device (e.g., a USB keyboard, a NIC, etc.);

(c) an error from the system's real time clock (RTC);

(d) an error from an I/O port; and

(e) expiration of an SMM timer that causes processing system 20 to enter SMM mode on a predetermined periodic basis, to support system management functions such as non-native USB processing and console redirection. The SMM timer may be implemented using the ICH/south bridge or other hardware or software timer-based system to drive the #SMI line of the processor, to cause chipset 34 to automatically generate an xMI on a predetermined periodic basis.

As indicated at block 212, once an xMI has been triggered, it causes processing system 20 to rendezvous processing units 30 and 32. For instance, when an xMI is triggered, all of the processing units may receive the xMI. In response to the xMI, all processing units may enter SMM, and the BSP may also vector to the SMM nub. In an example embodiment, processing unit 30 serves as the BSP, and it responds to an xMI by entering SMM and redirecting its instruction pointer to the first instruction in SMM nub 52. SMM nub 52 may then save the state of all processing unit (i.e., processing units 30 and 32), so that the state can be restored before control is returned to OS 64.

As depicted at block 214, SMM nub 52 may also set an OS timer, with a time limit corresponding to the amount of time that processing system 20 can stay in SMM without causing errors for OS 64. As indicated above, processing system 20 may also use an SMM timer to cause periodic entries into SMM, and once processing system 20 has entered SMM, that timer may be reset, as shown at block 216.

At block 220, SMM nub 52 may determine what kind of operations are necessary for handling the xMI, and whether those operations can be split up among multiple threads to be executed concurrently. For example, if SMM nub 52 determines that the xMI requires frame buffer 38 to be copied or “scraped” to support console redirection from processing system 20 to remote processing system 70, SMM nub 52 may conclude that the scrape operations are divisible. In block 222, SMM nub 52 may determine the actual division of labor to be used. For instance, SMM nub may determine that two threads can be used to scrape the frame buffer, with one thread to scrape the first half, and the other thread to scrape the second half. Similarly, if the xMI is associated with a memory error, SMM nub 52 may determine that a certain portion of RAM 26 needs to be refreshed, and that multiple threads (e.g., four threads) should be used to perform the refresh. Other numbers of threads may be used to perform the above functions or different functions in different embodiments.

As indicated at block 224, SMM nub 52 may then add event handlers for performing those functions to the thread queue. Alternatively, if SMM nub decided that a single thread should be sued, SMM nub may add a single event handler to the thread queue at block 224. The process may then pass through connector A to block 230.

Block 230 illustrates that a thread dispatcher in processing system 20 may monitor the thread queue to determine whether any even handlers have been queued. If an event handler has been queued, the thread dispatcher may then determine whether there are any processing units free to execute the thread, as shown at block 234. If a processing unit is available, the thread dispatcher may dispatch the event handler to the processing unit, and may remove the event handler from the thread queue, as shown at block 238. Thus, multiple processing units may concurrently execute multiple event handlers dispatched to service one or more xMI events.

Referring again to block 234, if there is no processing unit available to execute the queued event handler, the process may return to block 230. Once all event handlers have been dispatched, such that no more are left in the queue, the process may follow connector B to FIG. 3, and SMM nub 52 may determine whether all event handlers have finished executing, as shown at block 250. If so, SMM nub 52 may set the SMM timer to support periodic entry into SMM mode, as stated above and shown at block 252. SMM nub 52 may then cause the processing units to switch context back to legacy execution mode. In particular, SMM nub 52 may restore the state for each processing unit and cause the processing units to exit SMM, as indicated at blocks 254 and 256.

Referring again to block 238, after the thread dispatcher has dispatched one or more event handlers from the queue to one or more processing units, SMM nub 52 may determine whether any of the dispatched event handlers have failed, as shown at block 240. In one embodiment, SMM nub uses a function or instruction such as RunAsyncSmiEvent to dispatch event handlers to processing units. Also, a component such as an SMM dispatch monitor or a thread dispatch monitor issues a response or signal such as RunAsyncSmiComplete to SMM nub 52 for each event handler that successfully finishes execution. SMM nub 52 may set timers for some or all event handlers, and if the thread dispatch monitor has not generated an SMI complete signal for a handler within the specified time limit, SMM nub 52 may conclude that the handler has failed.

In one embodiment, the thread queue, the thread dispatcher, and the thread dispatch monitor are implemented as parts of SMM nub 52. In alternative embodiments, one or more of those components may be implemented as separate programs within SMM code 50.

When SMM nub 52 determines that an event handler has failed, SMM nub may then determine the cause for the failure and take corrective measures, as shown at block 242. SMM nub 52 may make this cause determination based in part on the specific event hander or the type of event handler that failed. For example, if the event handler that failed was a USB handler, SMM nub 52 may execute a routine that determines what caused the USB handler to fail. For instance, that routine may determine whether the configuration of the USB subsystem of processing system 20 was modified after the BIOS completed its boot process. This situation might occur, for example, if the BIOS originally configured the USB subsystem to use reactive, xMI-based event processing, but then a network OS subsequently reconfigured the USB subsystem to use polling to process events. The network OS may then terminate and return control to the BIOS. A USB event (e.g., an event triggered by an input device such as a USB keyboard) might then trigger an xMI, and SMM nub 52 might then queue an event handler to handle that xMI. However, that event handler might fail because the network OS reconfigured the USB subsystem.

Similarly, if a memory error handler for handling reliability, availability, and scalability (i.e., a memory RAS handler) fails, there is a good chance that memory error which triggered the xMI actually corrupted the memory error handler. When SMM nub 52 determines that a memory RAS handler has failed, SMM nub 52 may determine whether that the relevant error registers in the platform for the xMI (e.g., FERR/NERR or equivalent) correspond to an uncorrectable error. In the example embodiment, processing system 20 differentiates between different sources of xMIs related to error handling, based upon whether the errors are fatal or correctable. Consequently, SMM nub 52 may determine whether an error was fatal/uncorrectable based on the xMI source, possibly even without interrogating registers such as FERR/NERR. Thus, SMM nub 52 may determine whether an error is fatal based on base level registers and/or based upon the actual source of the xMI. If the memory error was an uncorrectable error, SMM nub 52 may take actions to log the error to the system management fabric.

After determining what caused the event handler to fail, SMM nub 52 may perform operations to correct the problem or problems that caused the failure. For instance, if a USB event handler failed and the configuration of the USB subsystem does not match the configuration set by the BIOS, SMM nub may re-enumerate the USB subsystem.

After correcting the problem or problems, SMM nub 52 may submit a new event handler to the queue to handle the original xMI, as shown at block 246. This new event handler may be a new instance of the same handler that failed, or possibly a new instance of a different handler.

For instance, if a memory event handler fails and SMM nub 52 determines that the errors seen in the hardware are correctable, SMM nub 52 may choose to run the handler again. If the handler still hangs or does not return in the time slice, the nub may simply restore state and exit SMM, returning operation to OS 64. Thus, SMM nub 52 may rely on the memory subsystem to correct the memory error, and SMM nub 52 may prevent the hung handler from causing the whole system to hang. One example situation in which an xMI handler could hang would be if the xMI handler was attempting to log a memory error to a remote system via a BMC, but an error in the BMC has caused communications between the BMC and the processor to fail.

Alternatively, in some circumstances, SMM nub 52 may log an error without launching another handler (e.g., in response to an uncorrectable memory error, as indicated above). In another embodiment, the SMM nub may launch another handler even if the error was uncorrectable or fatal. In some circumstances, after logging an error due to failure of an xMI handler, SMM nub 52 may reset the system.

In other circumstances, after logging, relaunching, or otherwise accounting for event handlers that failed, or after determining that the event handler queue is empty, the illustrated process may pass thru connector B to block 250 of FIG. 3, which shows that SMM nub 52 may determine whether any more xMIs have been received. For instance, when hardware in processing system 20 generates xMI, those xMIs may be stored in xMI registers 44 in chipset 34 until processed by SMM nub 52. Accordingly, SMM nub may check xMI registers 44 to determine whether any new xMIs have been received. The types of xMIs that may accumulate in xMI registers 44 include, without limitation, xMIs generated to provide display redirection for console redirection, xMIs generated by a USB subsystem in response to user input, xMIs generated in response to memory or other hardware errors, etc. In one embodiment, different xMI sources may each get an xMI register. In other embodiments, an xMI source may get multiple xMI registers, so that, if the source issued multiple xMIs, the processing system could store eventually process all of those xMIs.

If no new xMIs have been received, SMM nub 52 may determine whether all event handlers have finished executing, as depicted at block 260. This determination may be made based at least in part on data maintained by SMM nub 52 identifying the event handlers that have been queued, and the completion data returned to SMM nub 52 by the thread dispatch monitor, for example. If all event handlers have completed, SMM nub 52 may set one or more SMM timers to cause processing system 20 to re-enter SMM after a determined time period, as show at block 262. Such an SMM timer may be used to support console redirection, for example. SMM nub 52 may then restore the state to each processing unit, as shown at block 264. This state may be the state that was saved earlier, as described above in connection with block 212. All processing units may then exit SMM, with control returned to OS 64 in legacy execution mode, as depicted at block 266. The operations of restoring state and returning control to OS 64 may be referred to as a context switch out of SMM. Similarly, the operations of saving state and entering SMM may be referred to as a context switch into SMM.

Once control has been returned to OS 64, processing system 20 may operate in legacy execution mode until an xMI has been triggered, for instance in response to expiration of an SMM timer, as shown at blocks 280 and 282, or in response to any other type of xMI, as shown at block 210, which the illustrated process may reach via connector D.

However, referring again to block 260, if one or more event handlers are still executing, SMM nub 52 may determine whether the OS timer has expired, as shown at block 261. If the OS timer has expired, SMM nub 52 may save the current SMM state, as shown at block 272. The SMM state may include, for example, base processor registers, and other registers that may be changed by the overall nub(s) execution. SMM nub 52 may then cause processing system 20 to perform a context switch back to legacy execution mode, as described above in connection with blocks 262, 264, and 266. However, if the OS timer has not yet expired, the process may return to block 230 via connector A.

Referring again to block 250, if a new xMI has been received, SMM nub 52 may determine whether the OS timer has expired, as shown at block 270. If the OS timer has not yet expired, the process may return to block 220 via connector C. SMM nub may then handle that xMI according to the process described above, possibly splitting the task into various subtasks and dispatching subtasks to execute concurrently in different processing units.

The above process may be used to handle multiple xMIs in a single SMM session (e.g., without switching context back to protected mode). The above process may also be used to support remote system management through console redirection. For instance, processing system 20 may load SMM code 50 during the boot process, and then SMM code 50 may copy video data from frame buffers and transmit that data to a remote system for display. Furthermore, multiple threads may execute concurrently to copy the video data. In addition, processing system 20 may use timers to make sure that SMM does not consume so much time that it creates problems for OS 64, and may save SMM state so that SMM operations may be resumed after context is switched to OS 64 and back.

In light of the principles and example embodiments described and illustrated herein, it will be recognized that the illustrated embodiments can be modified in arrangement and detail without departing from such principles. Also, the foregoing discussion has focused on particular embodiments, but other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Similarly, although example processes have been described with regard to particular operations performed in a particular sequence, numerous modifications could be applied to those processes to derive numerous alternative embodiments of the present invention. For example, alternative embodiments may include processes that use fewer than all of the disclosed operations, processes that use additional operations, processes that use the same operations in a different sequence, and processes in which the individual operations disclosed herein are combined, subdivided, or otherwise altered.

Alternative embodiments of the invention also include machine accessible media encoding instructions for performing the operations of the invention. Such embodiments may also be referred to as program products. Such machine accessible media may include, without limitation, storage media such as floppy disks, hard disks, CD-ROMs, ROM, and RAM; and other detectable arrangements of particles manufactured or formed by a machine or device. Instructions may also be used in a distributed environment, and may be stored locally and/or remotely for access by single or multi-processor machines.

It should also be understood that the hardware and software components depicted herein represent functional elements that are reasonably self-contained so that each can be designed, constructed, or updated substantially independently of the others. In alternative embodiments, many of the components may be implemented as hardware, software, or combinations of hardware and software for providing the functionality described and illustrated herein.

In view of the wide variety of useful permutations that may be readily derived from the example embodiments described herein, this detailed description is intended to be illustrative only, and should not be taken as limiting the scope of the invention. What is claimed as the invention, therefore, is all implementations that come within the scope and spirit of the following claims and all equivalents to such implementations.

What is claimed is:

1. A method comprising:
after multiple event handlers have been dispatched to execute concurrently in different processing units of a processing system in a hidden execution mode, automatically determining whether the multiple event handlers successfully complete; and
if an event handler among the multiple dispatched event handlers fails, automatically dispatching another event handler to perform operations associated with the event handler that failed.

2. A method according to claim 1, further comprising:
in response to a hidden execution mode event pertaining to memory, automatically dispatching a first event handler to a first processing unit of the processing system, the first event handler to process a first portion of the memory; and
automatically dispatching a second event handler to a second processing unit of the processing system, the second event handler to process a second portion of the memory, the first and second event handlers to execute concurrently in the hidden execution mode.

3. A method according to claim 2, wherein:
the hidden execution mode event pertaining to memory comprises an event to support console redirection; and
the operations of automatically dispatching first and second event handlers comprise dispatching the first and second event handlers to execute concurrently in the hidden execution mode to read substantially different portions of a frame buffer of the processing system.

4. A method according to claim 1, wherein the hidden execution mode comprises a system management mode (SMM).

5. A method according to claim 1, wherein:
the hidden execution mode comprises a system management mode (SMM); and
the multiple event handlers are automatically dispatched to execute on different processing units in SMM in response to a hidden execution mode event.

6. A method according to claim 5, wherein the hidden execution mode event comprises an event from the group consisting of:
a system management interrupt (SMI); and
a platform management interrupt (PMI).

7. A method according to claim 1, further comprising:
in response to failure of a dispatched event handler, determining why the dispatched event handler failed and performing a corrective operation before dispatching another event handler to perform the operations associated with the event handler that failed.

8. A method according to claim 7, wherein the operation of automatically dispatching another event handler to perform operations associated with the event handler that failed comprises:
re-dispatching the event handler that failed after performing the corrective operation.

9. A method according to claim 1, further comprising:
receiving two or more interrupts in the processing system;
switching context from legacy execution mode to system management mode (SMM); and
handling the two or more interrupts in SMM without switching context from SMM to legacy execution mode;
wherein the interrupts comprises system management interrupts (SMIs) or platform management interrupts (PMIs).

10. A method comprising:
receiving two or more interrupts;
switching context from legacy execution mode to system management mode (SMM); and
handling the two or more interrupts in SMM without switching context from SMM to legacy execution mode;
wherein the interrupts comprises system management interrupts (SMIs) or platform management interrupts (PMIs).

11. A method according to claim 10, comprising:
switching context from legacy execution mode to SMM in response to a first one of the interrupts;
receiving a second one of the interrupts while in SMM; and
handling the first and second interrupts before switching context from SMM to legacy execution mode.

12. A method according to claim 10, wherein legacy execution mode comprises an execution mode from the group consisting of:
protected mode; and
real mode.

13. An apparatus comprising:
a machine-accessible medium; and
instructions in the machine-accessible medium, wherein the instructions, when executed by a processing system with multiple processing units that support a hidden execution mode, cause the processing system to perform operations comprising:
after multiple event handlers have been dispatched to execute concurrently in different processing units of a processing system in the hidden execution mode, automatically determining whether the dispatched event handlers successfully complete; and
if an event handler among the multiple dispatched event handlers fails, automatically dispatching another event handler to perform operations associated with the event handler that failed.

14. An apparatus according to claim 13, wherein the instructions cause the processing system to perform operations comprising:
in response to a hidden execution mode event pertaining to memory, automatically dispatching a first event handler to a first processing unit of the processing system, the first event handler to process a first portion of the memory; and
automatically dispatching a second event handler to a second processing unit of the processing system, the second event handler to process a second portion of the memory, the first and second event handlers to execute concurrently in the hidden execution mode.

15. An apparatus according to claim 14, wherein:
the hidden execution mode event pertaining to memory comprises an event to support console redirection; and
the operations of automatically dispatching first and second event handlers comprise dispatching the first and second event handlers to execute concurrently in the hidden execution mode to read substantially different portions of a frame buffer of the processing system.

16. An apparatus according to claim 13, wherein
the hidden execution mode comprises a system management mode (SMM); and
the instructions automatically dispatch the multiple event handlers to execute on different processing units in SMM in response to a hidden execution mode event.

17. An apparatus according to claim 16, wherein the hidden execution mode event comprises an event from the group consisting of:
a system management interrupt (SMI); and
a platform management interrupt (PMI).

18. An apparatus according to claim 13, wherein the instructions cause the processing system to perform operations comprising:
in response to failure of a dispatched event handler, determining why the dispatched event handler failed and performing a corrective operation before dispatching another event handler to perform the operations associated with the event handler that failed.

19. A processing system comprising:
event handlers for handling system management mode (SMM) events; and
an SMM nub to execute in SMM in processing system, the SMM nub (a) to dispatch multiple event handlers to execute concurrently in different processing units of the processing system in SMM, (b) to automatically determine whether the dispatched event handlers successfully complete, and (c) if an event handler among the dispatched event handlers fails, to automatically dispatch another event handler to perform operations associated with the event handler that failed.

20. A processing system according to claim 19, further comprising:
the SMM nub to detect a hidden execution mode event pertaining to memory in the processing system, and the SMM nub to respond to the hidden execution mode event by performing operations comprising:
automatically dispatching a first event handler to a first processing unit of the processing system, the first event handler to process a first portion of the memory; and
automatically dispatching a second event handler to a second processing unit of the processing system, the second event handler to process a second portion of the memory, the first and second event handlers to execute concurrently in SMM.

21. A processing system comprising:
event handlers for handling system management mode (SMM) events; and
an SMM nub to execute in SMM in processing system, the SMM nub to perform operations comprising:
detecting two or more hidden execution mode events;
switching context from legacy execution mode to system management mode (SMM) in response to one of the hidden execution mode events; and
using at least one of the event handlers to handle the two or more hidden execution mode events in SMM without switching context from SMM to legacy execution mode.

22. A processing system according to claim 21, comprising:
multiple processing units; and
the SMM nub to perform further operations comprising:
dispatching multiple event handlers to execute concurrently in different processing units of the processing system in SMM,
automatically determining whether the dispatched event handlers successfully complete; and
if an event handler among the dispatched event handlers fails, automatically dispatching another event handler to perform operations associated with the event handler that failed.
